(19) United States
(12) Patent Application Publication
(10) Pub. No.: US 2024/0354227 A1
(43) Pub. Date: Oct. 24, 2024

(54) ARTIFICIAL INTELLIGENCE VERIFICATION SYSTEM AND METHOD

(71) Applicant: SIMPLATFORM CO., LTD, Seoul (KR)

(72) Inventors: Dae Geun LIM, Daejeon (KR); Jin Wook KIM, Seoul (KR)

(21) Appl. No.: 18/759,829

(22) Filed: Jun. 29, 2024

Related U.S. Application Data
(63) Continuation of application No. PCT/KR2022/019013, filed on Nov. 29, 2022.

(30) Foreign Application Priority Data
Dec. 29, 2021 (KR) 10-2021-0190810

(51) Int. Cl. G06F 11/36

(52) U.S. Cl. CPC G06F 11/3664; G06F 11/3684

(57) ABSTRACT

A system for verifying artificial intelligence includes a sensing unit configured to receive process data from process equipment; a test data generation unit configured to generate test data by converting the process data; a simulation unit configured to read the test data and transmit the test data to the sensing unit in the same form as actual process data is transmitted; an abnormality determination unit configured to receive the test data transmitted from the simulation unit and determine whether there is an abnormality by using an artificial intelligence model; and an artificial intelligence verification unit configured to determine the adequacy of the artificial intelligence model by comparing the test data and the determination results of the abnormality determination unit.

### CROSS-REFERENCE TO RELATED APPLICATIONS

This application is a Continuation of International Application No. PCT/KR2022/019013 filed Nov. 29, 2022, which claims priority from Korean Application No. 10-2021-0190810 filed Dec. 29, 2021. The aforementioned applications are incorporated herein by reference in their entireties.

### TECHNICAL FIELD

The present invention relates to a system and method for verifying artificial intelligence, and more particularly to a system and method for analyzing whether artificial intelligence performing data analysis in an intelligent factory or the like is performing appropriate analysis operation.

### RELATED ART

As the introduction of artificial intelligence technology becomes more active, artificial intelligence technology is being used in various fields. In particular, in situations where multiple machines and processes need to be managed as in an intelligent factory, artificial intelligence is used to manage a complex process by monitoring the status of each of processes and machines, detecting an abnormal signal, and providing detection results to an administrator.

However, in the case of artificial intelligence technology, it is considerably difficult to verify whether an appropriate determination has been made because artificial intelligence technology only presents analysis results without providing a description of the determination process of determining whether there is an abnormality.

Korean Patent Application Publication No. 10-2020-090061 entitled “Method and Device for Verifying Artificial Neural Network model,” which is a prior art, is intended to verify such an artificial neural network, and provides the function of performing verification at a checkpoint generated as a learning process is performed. As described above, in the prior art, it is frequently verified whether artificial intelligence constructs an appropriate model during a learning process. There are difficulties in verifying whether artificial intelligence operates appropriately in actual application situations.

### SUMMARY

An object of the present invention is to determine whether artificial intelligence is operating appropriately through the verification of the artificial intelligence.

An object of the present invention is to enable the verification of artificial intelligence in an actual operating environment so that the verification of the artificial intelligence consistent with the actual environment can be performed.

An object of the present invention is to generate a separate test dataset and verify artificial intelligence so that the artificial intelligence can be verified without affecting an actual operating environment.

In order to accomplish the above object, an embodiment of the present invention provides a system for verifying artificial intelligence, the system including: a sensing unit configured to receive process data from process equipment; a test data generation unit configured to generate test data by converting the process data; a simulation unit configured to read the test data and transmit the test data to the sensing unit in the same form as actual process data is transmitted; an abnormality determination unit configured to receive the test data transmitted from the simulation unit and determine whether there is an abnormality by using an artificial intelligence model; and an artificial intelligence verification unit configured to determine the adequacy of the artificial intelligence model by comparing the test data and the determination results of the abnormality determination unit.

In this case, the test data generation unit may generate the test data by receiving parameters for the generation of outlier data and converting the process data through the application of the received parameters.

Furthermore, the parameters for the generation of the outlier data may include information about the adjustment of the highest/lowest values of the process data, and the test data generation unit may generate the test data by adjusting the highest/lowest values of part of the process data with reference to the information about the adjustment of the highest/lowest values of the parameters.

Furthermore, the test data generation unit may generate the test data by learning past actual data in which an abnormality occurred, detecting a pattern similar to a pattern before the occurrence of an abnormality in the process data, and performing the adjustment of the highest/lowest values on part of the process data after the detected pattern.

The present invention may achieve the effect of determining whether artificial intelligence is operating appropriately through the verification of the artificial intelligence.

The present invention may achieve the effect of enabling the verification of artificial intelligence in an actual operating environment so that the verification of the artificial intelligence consistent with the actual environment can be performed.

The present invention may achieve the effect of generating a separate test dataset and verifying artificial intelligence so that the artificial intelligence can be verified without affecting an actual operating environment.

### BRIEF DESCRIPTION OF THE DRAWINGS

FIG. 1 is a block diagram showing the internal configuration of a system for verifying artificial intelligence according to an embodiment of the present invention;

FIG. 2 is a diagram showing the hardware configuration of a case where a system for verifying artificial intelligence according to an embodiment of the present invention is applied;

FIG. 3 is a diagram showing an example of receiving and storing process data in a system for verifying artificial intelligence according to an embodiment of the present invention;

FIG. 4 is a diagram showing an example of generating test data in a system for verifying artificial intelligence according to an embodiment of the present invention;

FIG. 5 is a diagram showing an example of performing verification by using test data in a system for verifying artificial intelligence according to an embodiment of the present invention; and

FIG. 6 is a flowchart showing the flow of a method of verifying artificial intelligence according to an embodiment of the present invention.

### DETAILED DESCRIPTION

In order to accomplish the above object, an embodiment of the present invention provides a system for verifying artificial intelligence, the system including: a sensing unit configured to receive process data from process equipment; a test data generation unit configured to generate test data by converting the process data; a simulation unit configured to read the test data and transmit the test data to the sensing unit in the same form as actual process data is transmitted; an abnormality determination unit configured to receive the test data transmitted from the simulation unit and determine whether there is an abnormality by using an artificial intelligence model; and an artificial intelligence verification unit configured to determine the adequacy of the artificial intelligence model by comparing the test data and the determination results of the abnormality determination unit.

In this case, the test data generation unit may generate the test data by receiving parameters for the generation of outlier data and converting the process data through the application of the received parameters.

Furthermore, the parameters for the generation of the outlier data may include information about the adjustment of the highest/lowest values of the process data, and the test data generation unit may generate the test data by adjusting the highest/lowest values of part of the process data with reference to the information about the adjustment of the highest/lowest values of the parameters.

Furthermore, the test data generation unit may generate the test data by learning past actual data in which an abnormality occurred, detecting a pattern similar to a pattern before the occurrence of an abnormality in the process data, and performing the adjustment of the highest/lowest values on part of the process data after the detected pattern.

Preferred embodiments of the present invention will be described in detail below with reference to the accompanying drawings. In the description of the present invention, when it is determined that a detailed description of a related known configuration or function may obscure the gist of the present invention, the detailed description will be omitted. In addition, in the description of embodiments of the present invention, specific numerical values are only examples, and the scope of the invention is not limited thereby.

A system for verifying artificial intelligence according to the present invention may be configured in the form of a server that is equipped with a central processing unit (CPU) and memory and is connectable to another terminal over a communication network such as the Internet. However, the present invention is not limited by components such as the central processing unit, the memory, etc. In addition, the system for verifying artificial intelligence according to the present invention may be configured as a physical device, or may be implemented in a form distributed over a plurality of devices.

The operation of the system for verifying artificial intelligence of the present invention is approved according to the approval criteria and approval environment below.

### Approval Criteria

When one or more defects occur upon verification of an acceptance testing (AI verification) list, the time when all the defects have been treated is considered to be the completion time of acceptance testing (AI verification). When the system is operated normally according to the defined content of the testing, the testing is completed and the final confirmation of an external expert is obtained on a written acceptance test (AI verification) approval.

### Acceptance Testing (AI Verification) Environment

Acceptance testing (AI verification) is conducted in an actual operating environment. However, in order to verify the accuracy of an AI algorithm, it is impossible to verify it in such a manner as to artificially cause problems at a production site, so that a test dataset is prepared and verification is performed via test data.

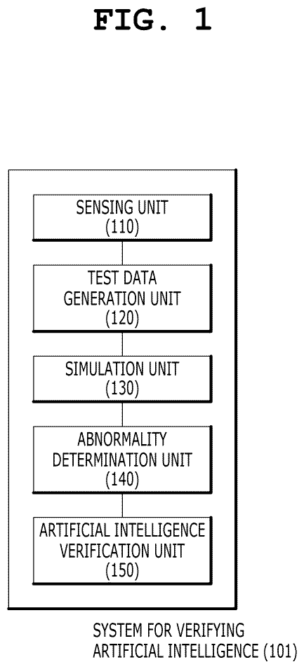

FIG. 1 is a block diagram showing the internal configuration of a system for verifying artificial intelligence according to an embodiment of the present invention.

The system 101 for verifying artificial intelligence according to an embodiment of the present invention may be configured to include a sensing unit 110, a test data generation unit 120, a simulation unit 130, an abnormality determination unit 140, and an artificial intelligence verification unit 150. The individual components may be software modules that operate within the same physical computer system, or may be configured such that two or more physically separated computer systems can operate in conjunction with each other. Various embodiments including the same function fall within the scope of the present invention.

The sensing unit 110 receives process data from process equipment. The process data is data generated from various types of process equipment. The process data may be data transmitted directly from the process equipment, or may be data collected from a monitoring device or sensor for monitoring the process equipment. In the case of an artificial intelligence system for monitoring a process, any abnormality in the process is detected using this process data. In order to check whether this artificial intelligence system appropriately detects an abnormality in the process, it is necessary to perform analysis by using data having the same type as actual process data.

When the process data is received from the sensing unit 110, it is determined whether there is an abnormality in the process equipment by analyzing this information through the artificial intelligence system. Accordingly, in order to check whether the artificial intelligence system operates normally, it is necessary to input data for testing to the sensing unit 110 and examine the results of the determination of whether there is an abnormality performed by the artificial intelligence system.

Accordingly, the sensing unit 110 needs to be configured to collect actual process data and also receive test data and to perform internal testing in the same manner in the artificial intelligence system.

The test data generation unit 120 generates test data by converting the process data. It is impossible to randomly generate an abnormal situation. Furthermore, when testing is conducted using randomly generated data, it is difficult to consider that testing is conducted in a situation that is the same as an actual situation. Accordingly, by generating outliers in such a manner as to store the process data collected from actual process equipment and then convert part of this data, it may be possible to check whether the artificial intelligence system can appropriately detect outliers when they occur in an actual process environment.

The test data generation unit 120 receives parameters for the generation of outlier data, and converts the process data by applying the received parameters, thereby generating test data. When test data is generated by converting actual process data, an administrator needs to set the degrees of application of outliers by using parameters and conduct testing in various environments in order to perform various tests to determine the extent to which the artificial intelligence system can detect outliers. Accordingly, the test data generation unit 120 may generate various types of test data by setting the different degrees of conversion of process data according to the parameters set by the administrator.

The parameters for the generation of outlier data received by the test data generation unit 120 include information about the adjustment of the highest/lowest values of the process data. Process data generally has values within the normal range, and outlier data often has specific values outside the normal range. Accordingly, outlier data may be generated by adjusting the highest and lowest values for data in a specific section. For example, when the parameters are set to convert the highest value into 200% and the lowest value into 30%, settings may be made such that the test data is generated by setting the highest value within the convertible section of the process data to be doubled and the lowest value thereof to be adjusted to 30%.

The test data generation unit 120 generates test data by adjusting the highest/lowest values of part of the process data with reference to the information about the adjustment of the highest/lowest values of the parameters. When the highest and lowest values of the process data are converted, it is desirable to perform the conversion by referring to past data in which an abnormal pattern actually occurred. It is important to convert data in a manner similar to the manner in which data may actually occur by adjusting not only the highest and lowest values but also the neighboring values of the highest and lowest values. For example, when the highest value is converted into 200%, the value immediately before the highest value is converted into 180% and the value before this value is converted into 160%, so that the data needs to be converted in a situation similar to an actual situation as much as possible.

Furthermore, the test data generation unit 120 may convert data by selectively increasing and decreasing time in such a manner as to adjust the time axis. By setting information about how to selectively increase and decrease the time in the above parameters, various types of test data may be generated.

The test data generation unit 120 detects a pattern similar to the pattern before the occurrence of an abnormality in the process data by learning past data in which an abnormality actually occurred, and generates test data by performing the adjustment of the highest/lowest values on the process data after the detected pattern. It is also considerably important to determine the section of the overall process data in which outliers will be generated. When outliers are randomly generated in any section, there may be a discrepancy from the actual error situation, making accurate testing difficult.

Therefore, the test data generation unit 120 checks the pattern in which an error occurred in the same process equipment in the past, searches for a pattern as similar as possible to this pattern within the overall process data, and then converts data so that outliers occur in the section after the pattern, thereby reproducing an actual error situation as closely as possible.

The test data generation unit 120 stores the test data generated through the above conversion in a storage device, and allows the administrator to utilize it when testing the artificial intelligence model of the artificial intelligence system.

The simulation unit 130 reads the test data and transmits it to the sensing unit in the same form as actual process data is transmitted. As described above, to test the artificial intelligence model of the artificial intelligence system by using test data, the test data needs to be input as if it were real data. Accordingly, the simulation unit 130 transmits the test data to the sensing unit 110 in the same form as the actual data is input.

In order to transmit the test data in the simulation unit 130 in the same form as actual data is transmitted, time-series data may be transmitted to the sensing unit 110 according to corresponding points in time. Through this, the sensing unit 110 operates as if time series data were input in real time, making it possible to test whether the artificial intelligence model of the actual artificial intelligence system operates accurately.

The abnormality determination unit 140 receives the test data transmitted from the simulation unit and determines whether there is an abnormality by using the artificial intelligence model. The abnormality determination unit 140 detects outliers in the input test data by using the artificial intelligence model that determines whether there is an abnormality in the actual process equipment. Therefore, after outliers have been forcibly generated and entered in test data, it may be checked whether the artificial intelligence model appropriately detects these outliers.

The abnormality determination unit 140 may utilize the system for determining an abnormality in actual process equipment without change, or may conduct testing by using a backup system to which the same artificial intelligence model applied to the system is applied.

The artificial intelligence verification unit 150 determines the adequacy of the artificial intelligence model by comparing the test data and the determination results of the abnormality determination unit. In the case where test data is converted and data containing outliers is input, when the anomaly determination unit 140 determines that there is an abnormality, it means that appropriate abnormality detection is being performed. Therefore, whether the artificial intelligence model is operating appropriately may be determined by comprehensively examining whether an abnormality is detected in test data containing outliers and whether it is determined that there is no abnormality in normal test data without outliers.

In this case, the artificial intelligence verification unit 150 may check the degree of conversion from which the artificial intelligence model can start to detect conversion by comparing the test results of a plurality of pieces of test data that are generated in such a manner that the administrator variously adjusts parameters. Through this, the accuracy of the artificial intelligence model may be analyzed.

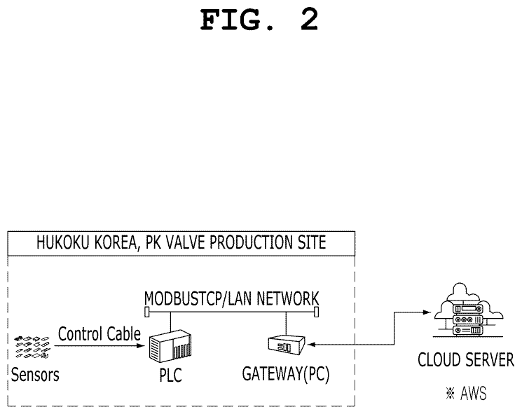

FIG. 2 is a diagram showing the hardware configuration of a case where a system for verifying artificial intelligence according to an embodiment of the present invention is applied.

As shown in the drawing, the system for verifying artificial intelligence according to the present invention may be configured to receive and analyze process data collected within a production site where actual process equipment is located. The system for verifying artificial intelligence may be located in a remote location, such as a cloud server, that can be connected to the production site through a gateway.

In the example of the drawing, an implementation may be made such that a gateway serves to receive process data and store the process data in a file system or the like as a file and the system for verifying artificial intelligence installed in a cloud server receives the process data and verifies the artificial intelligence model. This takes into consideration the practical problem in which it is difficult to have a system for verifying artificial intelligence within an actual production site, and the physical configuration may vary depending on the situation.

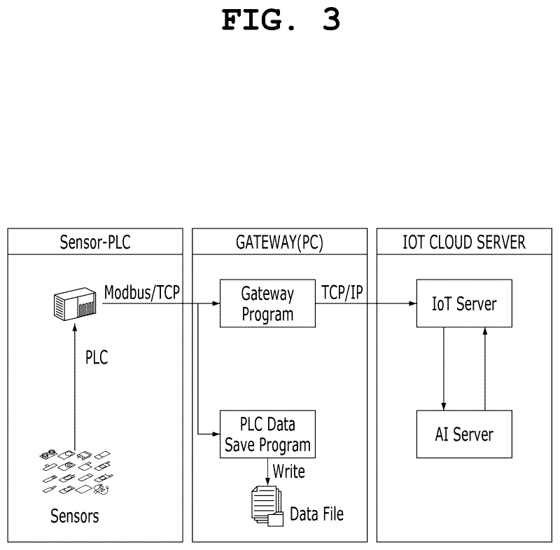

FIG. 3 is a diagram showing an example of receiving and storing process data in a system for verifying artificial intelligence according to an embodiment of the present invention.

As shown in the drawing, an artificial intelligence system (an AI server) located in an IoT cloud server detects or predicts outliers by analyzing process data by using an artificial intelligence model. Through this, a process may be managed efficiently.

In this case, the gateway may store the transmitted process data in a file form, and the system for verifying artificial intelligence installed in the cloud server may determine whether the artificial intelligence model is operating appropriately by analyzing the process data.

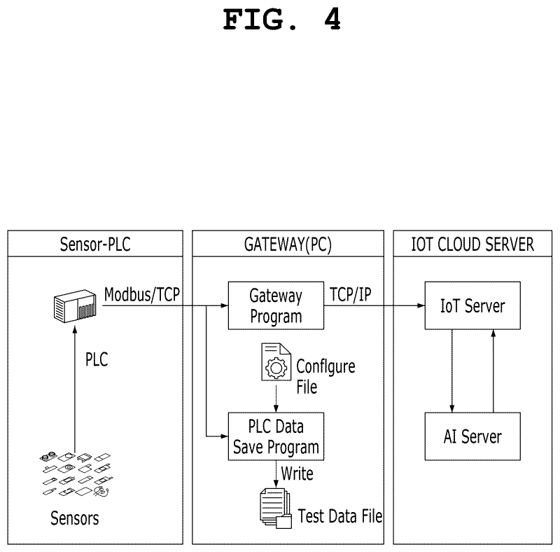

FIG. 4 is a diagram showing an example of generating test data in a system for verifying artificial intelligence according to an embodiment of the present invention.

As shown in the drawing, the gateway reads the parameter values stored in a configure file and converts the process data previously stored as shown in FIG. 3 based on the parameter values, thereby generating test data. In this case, as an administrator adjusts the parameter values recorded in the configure file, test data in various situations may be generated, making it possible to verify the artificial intelligence model from various perspectives.

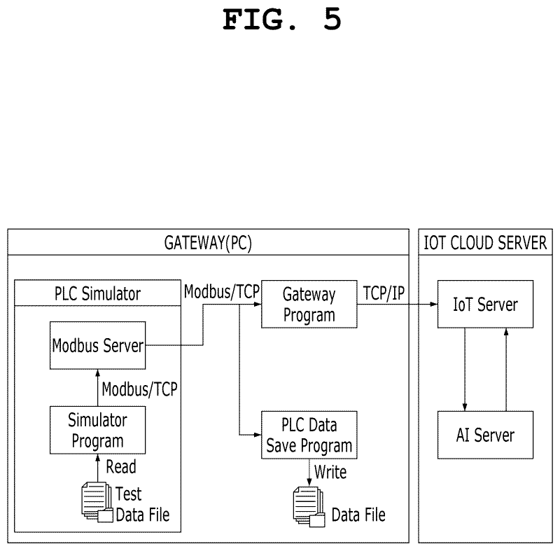

FIG. 5 is a diagram showing an example of performing verification by using test data in a system for verifying artificial intelligence according to an embodiment of the present invention.

As shown in the drawing, to verify the artificial intelligence model, the simulation unit (the PLC simulator in the drawing) rather than actual process equipment reads test data and transmits the test data to the artificial intelligence system located on the cloud server.

By transmitting test data transformed into outliers, rather than actual data, to the same system, it may be possible to verify whether the outliers can be accurately detected and predicted when the outliers occur.

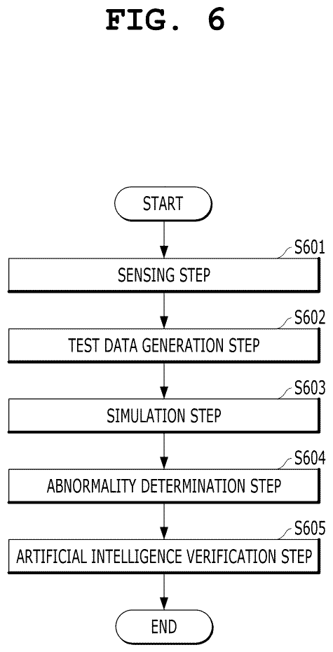

FIG. 6 is a flowchart showing the flow of a method of verifying artificial intelligence according to an embodiment of the present invention.

The method of verifying artificial intelligence according to the present invention is directed to a method of verifying artificial intelligence that operates in the system 101 for verifying artificial intelligence equipped with a central processing unit and memory, and may be performed in such a computing system.

Therefore, the method of verifying artificial intelligence includes all the characteristic configurations described for the system 101 for verifying artificial intelligence described above. Even when one or more components are omitted in the description below, they may be implemented by referring to the description of the artificial intelligence verification system 101 described above.

In sensing step S601, process data is received from process equipment. The process data is data generated from various types of process equipment. The process data may be data transmitted directly from the process equipment, or may be data collected from a monitoring device or sensor for monitoring the process equipment. In the case of an artificial intelligence system for monitoring a process, any abnormality in the process is detected using this process data. In order to check whether this artificial intelligence system appropriately detects an abnormality in the process, it is necessary to perform analysis by using data having the same type as actual process data.

When the process data is received in sensing step S601, it is determined whether there is an abnormality in the process equipment by analyzing this information through the artificial intelligence system. Accordingly, in order to check whether the artificial intelligence system operates normally, it is necessary to input data for testing to the sensing unit 110 and examine the results of the determination of whether there is an abnormality performed by the artificial intelligence system.

Therefore, sensing step S601 needs to be configured to collect actual process data and also receive test data and to perform internal testing in the same manner in the artificial intelligence system.

In test data generation step S602, test data is generated by converting the process data. It is impossible to randomly generate an abnormal situation. Furthermore, when testing is conducted using randomly generated data, it is difficult to consider that testing is conducted in a situation that is the same as an actual situation. Accordingly, by generating outliers in such a manner as to store the process data collected from actual process equipment and then convert part of this data, it may be possible to check whether the artificial intelligence system can appropriately detect outliers when they occur in an actual process environment.

In test data generation step S602, test data is generated by receiving parameters for the generation of outlier data and converting the process data through the application of the received parameters. When test data is generated by converting actual process data, an administrator needs to set the degrees of application of outliers by using parameters and conduct testing in various environments in order to perform various tests to determine the extent to which the artificial intelligence system can detect outliers. Accordingly, the test data generation unit 120 may generate various types of test data by setting the different degrees of conversion of process data according to the parameters set by the administrator.

The parameters for the generation of outlier data received in test data generation step S602 include information about the adjustment of the highest/lowest values of the process data. Process data generally has values within the normal range, and outlier data often has specific values outside the normal range. Accordingly, outlier data may be generated by adjusting the highest and lowest values for data in a specific section. For example, when the parameters are set to convert the highest value into 200% and the lowest value into 30%, settings may be made such that the test data is generated by setting the highest value within the convertible section of the process data to be doubled and the lowest value thereof to be adjusted to 30%.

In test data generation step S602, test data is generated by adjusting the highest/lowest values of part of the process data with reference to the information about the adjustment of the highest/lowest values of the parameters. When the highest and lowest values of the process data are converted, it is desirable to perform the conversion by referring to past data in which an abnormal pattern actually occurred. It is important to convert data in a manner similar to the manner in which data may actually occur by adjusting not only the highest and lowest values but also the neighboring values of the highest and lowest values. For example, when the highest value is converted into 200%, the value immediately before the highest value is converted into 180% and the value before this value is converted into 160%, so that the data needs to be converted in a situation similar to an actual situation as much as possible.

Furthermore, in test data generation step S602, data may be converted by selectively increasing and decreasing time in such a manner as to adjust the time axis. By setting information about how to selectively increase and decrease the time in the above parameters, various types of test data may be generated.

In test data generation step S602, a pattern similar to the pattern before the occurrence of an abnormality in the process data is detected by learning past data in which an abnormality actually occurred, and test data is generated by performing the adjustment of the highest/lowest values on the process data after the detected pattern. It is also considerably important to determine the section of the overall process data in which outliers will be generated. When outliers are randomly generated in any section, there may be a discrepancy from the actual error situation, making accurate testing difficult.

Therefore, in test data generation step S602, the pattern in which an error occurred in the same process equipment in the past is checked, a pattern as similar as possible to this pattern within the overall process data is searched for, and then data is converted such that outliers occur in the section after the pattern, thereby reproducing an actual error situation as closely as possible.

In test data generation step S602, the test data generated through the above conversion is stored in a storage device, and the administrator is allowed to utilize the stored test data when testing the artificial intelligence model of the artificial intelligence system.

In simulation step S603, the test data is read and transmitted to the sensing unit in the same form as actual process data. As described above, to test the artificial intelligence model of the artificial intelligence system by using test data, the test data needs to be input as if it were real data. Accordingly, the simulation unit 130 transmits the test data to the sensing unit 110 in the same form as the actual data is input.

In order to transmit the test data in simulation step S603 in the same form as actual data is transmitted, time-series data may be transmitted to sensing step S601 according to corresponding points in time. Through this, sensing step S601 operates as if time series data were input in real time, making it possible to test whether the artificial intelligence model of the actual artificial intelligence system operates accurately.

In abnormality determination step S604, the test data transmitted from the simulation unit is received, and whether there is an abnormality is determined using the artificial intelligence model. The abnormality determination unit 140 detects outliers in the input test data by using the artificial intelligence model that determines whether there is an abnormality in the actual process equipment. Therefore, after outliers have been forcibly generated and entered in test data, it may be checked whether the artificial intelligence model appropriately detects these outliers.

In abnormality determination step S604, the system for determining an abnormality in actual process equipment may be utilized without change, or testing may be conducted using a backup system to which the same artificial intelligence model applied to the system is applied.

In artificial intelligence verification step S605, the adequacy of the artificial intelligence model is determined by comparing the test data and the determination results of the abnormality determination unit. In the case where test data is converted and data containing outliers is input, when the anomaly determination unit 140 determines that there is an abnormality, it means that appropriate abnormality detection is being performed. Therefore, whether the artificial intelligence model is operating appropriately may be determined by comprehensively examining whether an abnormality is detected in test data containing outliers and whether it is determined that there is no abnormality in normal test data without outliers.

In this case, in artificial intelligence verification step S605, the degree of conversion from which the artificial intelligence model can start to detect conversion may be checked by comparing the test results of a plurality of pieces of test data that are generated in such a manner that the administrator variously adjusts parameters. Through this, the accuracy of the artificial intelligence model may be analyzed.

The method of verifying artificial intelligence according to the present invention may be produced as a program that causes a computer to perform the method of verifying artificial intelligence, and may be recorded on a computer-readable storage medium.

Examples of the computer-readable storage medium include magnetic media such as hard disks, floppy disks and magnetic tapes, optical storage media such as CDROMs and DVDs, magneto-optical media such as floptical disks, and hardware devices specially configured to store and execute program instructions, such as ROM, RAM, flash memory, and the like.

Examples of the program instructions include high-level language codes executable by a computer using an interpreter or the like as well as machine language codes such as those produced by a compiler. The hardware devices may each be configured to act as one or more software modules in order to perform processing according to the present invention, and vice versa.

Although the foregoing description has been given with reference to the embodiments, those skilled in the art may modify and alter the present invention in various manners without departing from the spirit and scope of the present invention described in the claims below.

### INDUSTRIAL APPLICABILITY

A system for verifying artificial intelligence according to an embodiment of the present invention may be configured to include: a sensing unit configured to receive process data from process equipment; a test data generation unit configured to generate test data by converting the process data; a simulation unit configured to read the test data and transmit the test data to the sensing unit in the same form as actual process data is transmitted; an abnormality determination unit configured to receive the test data transmitted from the simulation unit and determine whether there is an abnormality by using an artificial intelligence model; and an artificial intelligence verification unit configured to determine the adequacy of the artificial intelligence model by comparing the test data and the determination results of the abnormality determination unit.

What is claimed is:

1. A system for verifying artificial intelligence, the system comprising:
a sensing unit configured to receive process data from process equipment;
a test data generation unit configured to generate test data by converting the process data;
a simulation unit configured to read the test data and transmit the test data to the sensing unit in the same form as actual process data is transmitted;
an abnormality determination unit configured to receive the test data transmitted from the simulation unit and determine whether there is an abnormality by using an artificial intelligence model; and
an artificial intelligence verification unit configured to determine adequacy of the artificial intelligence model by comparing the test data and determination results of the abnormality determination unit.

2. The system of claim 1, wherein the test data generation unit generates the test data by receiving parameters for generation of outlier data and converting the process data through application of the received parameters.

3. The system of claim 2, wherein the parameters for the generation of the outlier data include information about adjustment of highest/lowest values of the process data, and
wherein the test data generation unit generates the test data by adjusting highest/lowest values of part of the process data with reference to the information about the adjustment of the highest/lowest values of the parameters.

4. The system of claim 3, wherein the test data generation unit generates the test data by learning past actual data in which an abnormality occurred, detecting a pattern similar to a pattern before occurrence of an abnormality in the process data, and performing adjustment of highest/lowest values on part of the process data after the detected pattern.

5. A method of verifying artificial intelligence, the method operating in a system for verifying artificial intelligence equipped with a central processing unit and memory, the method comprising:
a sensing step of receiving process data from process equipment;
a test data generation step of generating test data by converting the process data;
a simulation step of reading the test data and transmitting it to the sensing step in the same form as actual process data is transmitted;
an abnormality determination step of receiving the test data transmitted in the simulation step and determining whether there is an abnormality by using an artificial intelligence model; and
an artificial intelligence verification step of determining adequacy of the artificial intelligence model by comparing the test data and determination results of the abnormality determination step.

6. The method of claim 5, wherein the test data generation step generates the test data by receiving parameters for generation of outlier data and converting the process data through application of the received parameters.

7. The method of claim 6, wherein the parameters for the generation of the outlier data include information about adjustment of highest/lowest values of the process data, and
wherein the test data generation step generates the test data by adjusting highest/lowest values of part of the process data with reference to the information about the adjustment of the highest/lowest values of the parameters.

8. The method of claim 7, wherein the test data generation step generates the test data by learning past actual data in which an abnormality occurred, detecting a pattern similar to a pattern before occurrence of an abnormality in the process data, and performing adjustment of highest/lowest values on part of the process data after the detected pattern.

9. A non-transitory computer-readable storage medium having stored thereon a program that causes a computer to execute the method of claim 5.
